(19) United States
(12) Patent Application Publication
(10) Pub. No.: US 2007/0293626 A1
(43) Pub. Date: Dec. 20, 2007

(54) Polyamide blend compositions

(76) Inventors: Shreyas Chakravarti, Evansville, IN (US); Keshav S. Gautam, Evansville, IN (US); Sung Dug Kim, Newburgh, IN (US); Ganesh Kannan, Evansville, IN (US)

Correspondence Address: SABIC - O8CV - CPP;SABIC Innovative Plastics - IP Legal, ONE PLASTICS AVENUE, PITTSFIELD, MA, 01201-3697, US

(21) Appl. No.: 11/296,626

(22) Filed: Dec. 7, 2005

(51) Int. Cl. C08G 63/44; C08G 69/44

(52) U.S. Cl. 524/599; 525/451

(57) ABSTRACT

A composition comprising composition comprising a polymer blend of a polyamide resin and block copolyestercarbonates resin comprising organic carbonate blocks alternating with arylate blocks, said arylate blocks comprising arylate structural units derived from a 1,3-dihydroxybenzene and at least one aromatic dicarboxylic acid and having a degree of polymerization of at least about 4. The composition preferable has favorable properties of clarity and chemical resistance.

### FIELD OF THE INVENTION

The invention relates to polyamide polymer blends, especially blends having a desired clarity and other favorable properties.

### BACKGROUND OF THE INVENTION

Polyamides especially amorphous polyamides (a-PA) are interesting engineering thermoplastics with excellent mechanical, barrier and chemical properties with the added advantage of transparency. This combination makes these materials unique to many applications in the industries that require performance along with good chemical resistance and optical clarity. The superior barrier properties of these materials translate also to their wide application in the packaging industry. Further, amorphous polyamides have been well known for their excellent chemical resistance to a wide range of commonly used chemicals. However, the polyamide has relatively low chemical resistance to hydrophilic chemicals and shows only marginal weatherability. The incompatibility of polyamides with other polymers makes it difficult to design useful blends especially under constraints of maintaining the clarity in these systems. There is a need for transparent blends of thermoplastic resins with polyamides having both enhanced ESCR performance together with good weathering properties.

U.S. Pat. No. 4,877,848 relates to thermoplastic blends containing polyamide and epoxy functional compound wherein the blends include a resin selected from the group consisting of polycarbonate, poly(ester-carbonate), and polyarylate.

U.S. Pat. Nos. 6,559,270 and 6,583,256, describe weatherable block copolyestercarbonates and blends containing them. The blending of copolyestercarbonates with other polymers such as polycarbonates, poly(alkylene carboxylates), polyarylates, polyetherimides are described.

### SUMMARY OF THE INVENTION

According to an embodiment, there is provided a composition comprising a polymer blend of a polyamide resin and block copolyestercarbonates resin comprising organic carbonate blocks alternating with arylate blocks, said arylate blocks comprising arylate structural units derived from a 1,3-dihydroxybenzene and at least one aromatic dicarboxylic acid and having a degree of polymerization of at least about 4.

According to an embodiment, the polyamide resin comprises an amorphous polyamide resin. According to an embodiment, the polyamide resin is immiscible with the copolyestercarbonates resin. According to an embodiment, the composition preferable has favorable properties of clarity and chemical resistance.

According to an embodiment, the composition comprises thermally stable and chemically resistant clear aromatic polyamide blends. According to an embodiment, the composition of the resorcinol-based copolymer is controlled so that the resulting copolymer will have a refractive index very close to that of the polyamide of interest. According to an embodiment, the immiscible resorcinol based copolymer comprises a blend of miscible polymers having a resulting refractive index very close to that of the polyamide of interest. According to an embodiment, the transparency achieved may have greater than 75% light transmission and in most cases with clarity comparable to the individual polymers.

According to an embodiment, additional ingredients in the resin formulation may enhance processing, and thermal, and color stability of transparent resin formulations.

According to an embodiment, such additional ingredients may include polymeric ionomers, multifunctional epoxies, or oxazoline compositions, colorants and mixtures of such added ingredients.

### BRIEF DESCRIPTION OF THE DRAWING

FIG. 1 shows % Haze of Selar with PC/ITR-PC copolymer blends where the RI of the PC/ITR-PC copolymer blends are varied to match the RI of the Selar. The refractive index on the x-axis is calculated based on weight fraction of PC/ITR20/ITR60.

### DETAILED DESCRIPTION OF THE INVENTION

An immiscible polymer blend includes one or more polyamide resins and copolyestercarbonates resin comprising organic carbonate blocks alternating with arylate blocks, said arylate blocks comprising arylate structural units derived from a 1,3-dihydroxybenzene and at least one dicarboxylic acid and having a degree of polymerization of at least 4.

Polyamide resin includes a generic family of resins known as nylons, characterized by the presence of an amide group (—C(O)NH—) and may be aliphatic, aromatic or a combination of aliphatic and aromatic. Preferred properties include optical transparency. Useful polyamide resins include all known polyamides and include polyamide, polyamide-6,6, polyamide-1 1, polyamide-12, polyamide-4,6, polyamide-6,10 and polyamide-6,12, as well as polyamides prepared from terephthalic acid and/or isophthalic acid and trimethylhexamethylenediamine; from adipic acid and m-xylenediamines; from adipic acid, azelaic acid, 2,2-bis-(p-aminocyclohexyl)propane, and from terephthalic acid and 4,4′-diaminodicyclohexylmethane. Mixtures and/or copolymers of two or more of the foregoing polyamides or prepolymers thereof, respectively, are also within the scope of the present invention. Useful examples of the polyamides or nylons, as these are often called, include for example: polypyrrolidone (nylon 4), polycaprolactam (nylon 6), polycaprolactam (nylon 8), polyhexamethylene adipamide (nylon 6,6), polyundecanolactam (nylon 11), polyundecanolactam (nylon 12), polyhexamethylene azelaiamide (nylon 6,9), polyhexamethylene, sebacamide (nylon 6,10), polyhexamethylene isophthalimide (nylon 6,1), polyhexamethylene terephthalamide (nylon 6,T), polyamide of hexamethylene diamine and n-dodecanedioic acid (nylon 6,12) as well as polyamides resulting from terephthalic acid and/or isophthalic acid and trimethyl hexamethylene diamine, polyamides resulting from adipic acid and meta xylenediamines, polyamides resulting from adipic acid, azelaic acid and 2, 2-bis-(p-aminocyclohexyl)propane and polyamides resulting from terephthalic acid and 4,4′-diamino-dicyclohexylmethane.

One polyamide resin is an aliphatic polyamide resin and includes linear, branched and cycloaliphatic polyamides. These polyamides include the family of resins known generically as nylons, which are characterized by the presence of an amide group, and are represented generally by Formula 2 and Formula 3: 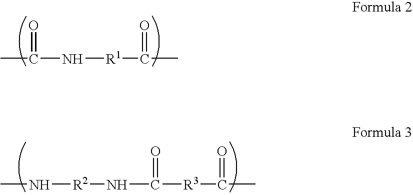
wherein R1-3 are each independently C1 to C20 alkyl, C1 to C20 cycloalkyl, and the like. For aromatic polyamides, at least one of R1-3 comprises an aromatic radical preferable a phenylene group. The preferred polyamides are characterized by their optical transparency.

Polyamides include Nylon-6 (Formula 2, wherein R1 is C4 alkyl) and nylon-6,6 (Formula 4, wherein R2 and R3 are each C4 alkyl). Other useful polyamides include nylon-4,6, nylon-12, nylon-6,10, nylon 6,9, nylon 6/6T and nylon 6,6/6T with triamine contents below about 0.5 weight %, and a polyamide, PACM 12, of formula 3 wherein, R2 is di-(4-aminocyclohexyl) methane and R3 is dodecane diacid. Still others include amorphous nylons.

The polyamides may be made by any known method, including the polymerization of a monoamino monocarboxylic acid or a lactam thereof having at least 2 carbon atoms between the amino and carboxylic acid group, of substantially equimolar proportions of a diamine which contains at least 2 carbon atoms between the amino groups and a dicarboxylic acid, or of a monoaminocarboxylic acid or a lactam thereof as defined above, together with substantially equimolar proportions of a diamine and a dicarboxylic acid. The dicarboxylic acid may be used in the form of a functional derivative thereof, for example, a salt, an ester or acid chloride.

Polyamides can be obtained by a number of processes, such as those described in U.S. Pat. Nos. 2,071,250; 2,071,251; 2,130,523; 2,130,948; 2,241,322; 2,312,966; and 2,512,606. Specifically, Nylon-6 is a polymerization product of caprolactam. Nylon-6, 6 is a condensation product of adipic acid and 1,6-diaminohexane. Likewise, nylon 4,6 is a condensation product between adipic acid and 1,4-diaminobutane. Besides adipic acid, other useful diacids for the preparation of nylons include azelaic acid, sebacic acid, dodecane di-acid, and the like. Useful diamines include, for example, di-(4-aminocyclohexyl)methane; 2,2-di-(4-aminocyclohexyl)propane, among others. A preferred polyamide is PACM 12, wherein R2 is di-(4-aminocyclohexyl) methane and R3 is dodecane diacid, as described in U.S. Pat. No. 5,360,891. Copolymers of caprolactam with diacids and diamines are also useful.

Suitable aliphatic polyamides have a viscosity of at least about 90, preferably at least about 110 milliliters per gram (ml/g); and also have a viscosity less than about 400, preferably less than about 350 ml/g as measured in a 0.5 wt % solution in 96 wt % sulphuric acid in accordance with ISO 307.

The polyamide used may also be one or more of those referred to as “toughened nylons”, which are often prepared by blending one or more polyamides with one or more polymeric or copolymeric elastomeric toughening agents. Examples of these types of materials are given in U.S. Pat. Nos. 4,174,358; 4,474,927; 4,346,194; 4,251,644; 3,884,882; 4,147,740; all incorporated herein by reference, as well as in a publication by Gallucci et al, “Preparation and Reactions of Epoxy-Modified Polyethylene”, J. APPL. POLY. SCI., V. 27, PP, 425-437 (1982). The preferred polyamides for this invention are polyamide-6; 6,6; 11 and 12, with the most preferred being polyamide-6,6. The polyamides used herein preferably have an intrinsic viscosity of from about 0.4 to about 2.0 dl/g as measured in a 60:40 m-cresol mixture or similar solvent at 23°-30° C.

It is within the skill of persons knowledgeable in the art to produce amorphous polyamides through any one of a combination of several methods. Faster polyamide melt cooling tends to result in an increasingly amorphous resin. Side chain substitutions on the polymer backbone, such as the use of a methyl group to disrupt regularity and hydrogen bonding, may be employed. Non-symmetric monomers, for instance, odd-chain diamines or diacids and meta aromatic substitution, may prevent crystallization. Symmetry may also be disrupted through copolymerization, that is, using more than one diamine, diacid or monoamino-monocarboxylic acid to disrupt regularity. In the case of copolymerization, monomers which normally may be polymerized to produce crystalline homopolymer polyamides, for instance, nylon-6, 6/6, 11, 6/3, 4/6, 6/4, 6/10, or 6/12, or 6,T may be copolymerized to produce a random amorphous copolymer. Amorphous polyamides for use herein are generally transparent with no distinct melting point, and the heat of fusion is about 1 cal/gram or less. The heat of fusion may be conveniently determined by use of a differential scanning calorimeter (DSC). One amorphous polyamide is poly(hexamethylene isophthalamide), commonly referred to as nylon-6,I. Nylon-6,I is prepared by reacting hexamethylene diamine with isophthalic acid or its reactive ester or acid chloride derivatives.

Blends of various polyamide resins as the polyamide component can comprise from about 1 to about 99 parts by weight preferred polyamides as set forth above and from about 99 to about 1 part by weight other polyamides based on 100 parts by weight of both components combined. Other polyamide resins, however, such as nylon-4,6, nylon-12, nylon-6,10, nylon 6,9, nylon 6/6T, nylon 6,6/6T, and nylon 9T with triamine contents below about 0.5 weight percent (wt %), as well as others, such as the amorphous nylons, may be useful in the poly(arylene ether)/polyamide composition. Mixtures of various polyamides, as well as various polyamide copolymers, may also be useful. The polyamide resin has a weight average molecular weight (Mw) greater than or equal to about 75,000, preferably greater than or equal to about 79,000, and more preferably greater than or equal to about 82, 000 as determined by gel permeation chromatography.

The immiscible polymer blend includes a second resin comprising a block copolyestercarbonates resin comprising organic carbonate blocks alternating with arylate blocks, said arylate blocks comprising arylate structural units derived from a 1,3-dihydroxybenzene. The block copolyestercarbonates of the present invention comprise alternating carbonate and arylate blocks. They include polymers comprising moieties of the formula 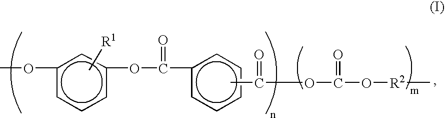
wherein R1 is hydrogen, halogen or C1-4 alkyl, each R2 is independently a divalent organic radical, m is at least about 10 and n is at least about 4. The arylate blocks thus contain a 1,3-dihydroxybenzene moiety which may be substituted with halogen, usually chorine or bromine, or with C1-4 alkyl; i.e., methyl, ethyl, propyl or butyl. Said alkyl groups are preferably primary or secondary groups, with methyl being more preferred, and are most often located in the ortho position to both oxygen atoms although other locations are also contemplated. The most preferred moieties are resorcinol moieties, in which R1 is hydrogen. The arylate blocks have a degree of polymerization (DP), represented by n, of at least about 4, preferably at least about 10, more preferably at least about 20 and most preferably about 30-150. The DP of the carbonate blocks, represented by m, is generally at least about 10, preferably at least about 20 and most preferably about 50-200.

The distribution of the blocks may be such as to provide a copolymer having any desired weight proportion of arylate blocks in relation to carbonate blocks. In general, copolymers containing about 10-90% by weight arylate blocks are preferred.

Said 1,3-dihydroxybenzene moieties are bound to aromatic dicarboxylic acid moieties which may be monocyclic moieties, e.g., isophthalate or terephthalate, or polycyclic moieties, e.g., naphthalenedicarboxylate. Preferably, the aromatic dicarboxylic acid moieties are isophthalate and/or terephthalate. Either or both of said moieties may be present. For the most part, both are present in a molar ratio of isophthalate to terephthalate in the range of about 0.25-4.0:1, preferably about 0.8-2.5:1.

In step A of the method of this invention for the preparation of block copolyestercarbonates, a 1,3-dihydroxybenzene which may be resorcinol (preferably) or an alkyl- or haloresorcinol may be contacted under aqueous alkaline reactive conditions with at least one aromatic dicarboxylic acid chloride, preferably isophthaloyl chloride, terephthaloyl chloride or a mixture thereof. The alkaline conditions are typically provided by introduction of an alkali metal hydroxide, usually sodium hydroxide. A catalyst, most often a tetraalkylammonium, tetraalkylphosphonium or hexaalkylguanidinium halide, is usually also present, as is an organic solvent, generally a water-immiscible solvent and preferably a chlorinated aliphatic compound such as methylene chloride. Thus, the reaction is generally conducted in a 2-phase system.

In order to afford a hydroxy-terminated polyester intermediate, the molar ratio of resorcinol to acyl chlorides is preferably greater than 1:1; e.g., in the range of about 1.01-1.90:1. Base may be present in a molar ratio to acyl halides of about 2-2.5:1. Catalyst is usually employed in the amount of about 0.1-10 mole percent based on combined acyl halides. Reaction temperatures are most often in the range of about 25-50° C.

Following the completion of polyester intermediate preparation, it is sometimes advantageous to acidify the aqueous phase of the two-phase system with a weak acid prior to phase separation. The organic phase, which contains the polyester intermediate, is then subjected to step B which is the block copolyestercarbonate-forming reaction. It is also contemplated, however, to proceed to step B without acidification or separation, and this is often possible without loss of yield or purity.

It is also within the scope of the invention to prepare the polyester intermediate entirely in an organic liquid, with the use of a base soluble in said liquid. Suitable bases for such use include tertiary amines such as triethylamine.

In the carbonate blocks, each R2 is independently an organic radical. For the most part, at least about 60 percent of the total number of R2 groups in the polymer are aromatic organic radicals and the balance thereof are aliphatic, alicyclic, or aromatic radicals. Suitable R2 radicals include m-phenylene, p-phenylene, 4,4′-biphenylene, 4,4′-bi(3,5-dimethyl)-phenylene, 2,2-bis(4-phenylene)propane and similar radicals such as those which correspond to the dihydroxy-substituted aromatic hydrocarbons disclosed by name or formula (generic or specific) in U.S. Pat. No. 4,217,438, which is incorporated herein by reference.

More preferably, each R2 is an aromatic organic radical and still more preferably a radical of the formula
-A¹-Y-A², (II)
wherein each A1 and A2 is a monocyclic divalent aryl radical and Y is a bridging radical in which one or two carbon atoms separate A1 and A2. The free valence bonds in formula II are usually in the meta or para positions of A1 and A2 in relation to Y. Compounds in which R2 has formula II are bisphenols, and for the sake of brevity the term “bisphenol” is sometimes used herein to designate the dihydroxy-substituted aromatic hydrocarbons; it should be understood, however, that non-bisphenol compounds of this type may also be employed as appropriate.

In formula II, A1 and A2 typically represent unsubstituted phenylene or substituted derivatives thereof, illustrative substituents (one or more) being alkyl, alkenyl, and halogen (particularly bromine). Unsubstituted phenylene radicals are preferred. Both A1 and A2 are preferably p-phenylene, although both may be o- or m-phenylene or one o- or m-phenylene and the other p-phenylene.

The bridging radical, Y, is one in which one or two atoms, separate A1 from A2. The preferred embodiment is one in which one atom separates A1 from A2. Illustrative radicals of this type are —O—, —S—, —SO— or —SO2-, methylene, cyclohexyl-methylene, 2-[2.2.1]-bicycloheptyl methylene, ethylene, isopropylidene, neopentylidene, cyclohexylidene, cyclopentadecylidene, cyclododecylidene, adamantylidene, and the 2,2,2′,2′-tetrahydro-3,3,3′,3′-tetramethyl-1,1′spirobi[1H-indene]6,6′-diols having the following formula;

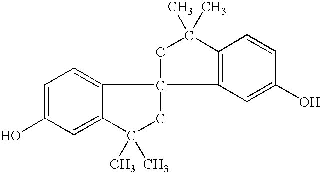

Gem-alkylene(alkylidene) radicals are preferred. Also included, however, are unsaturated radicals. For reasons of availability and particular suitability for the purposes of this invention, the preferred bisphenol is 2,2-bis(4-hydroxyphenyl)propane (“BPA”), in which Y is isopropylidene and A1 and A2 are each p-phenylene.

The dihydroxyaromatic compound employed in the second step typically has the formula HO—R2-OH, wherein R2 is as previously defined. Bisphenol A is generally preferred. The carbonyl halide is preferably phosgene. This reaction may be conducted according to art-recognized interfacial procedures (i.e., also in a 2-phase system), employing a suitable interfacial polymerization catalyst and an alkaline reagent, again preferably sodium hydroxide, and optionally a branching agent such as 1,1,1-tris(4-hydroxyphenyl)ethane and/or a chain termination agent such as phenol or p-cumylphenol. To suppress scrambling of the block copolymer, the pH is maintained at a relatively low level, typically in the range of about 5-9, for the initial part of the phosgenation reaction; it may be increased to about 10-13 during the latter part of said reaction.

Following completion of both reactions, the block copolyestercarbonate may be isolated by conventional procedures. These may include, for example, anti-solvent precipitation, drying and pelletization via extrusion. It is also contemplated to conduct the first step by other ester-forming methods, as illustrated by transesterification using aromatic diesters and a 1,3-dihydroxybenzene either in a solvent or in the melt.

The block copolyestercarbonates of this invention are polymers having excellent physical properties. Their light transmitting properties are similar to those of polycarbonates. Thus, they are substantially transparent and may be employed as substitutes for polycarbonates in the fabrication of transparent sheet material when improved weatherability is mandated.

It is believed that the weatherability and other beneficial properties of the block copolyestercarbonates of the invention is attributable, at least in part, to the occurrence of a thermally or photochemically induced Fries rearrangement of the arylate blocks therein, to yield benzophenone moieties which serve as light stabilizers. For example, the moieties of formula I can rearrange to yield moieties of the formula 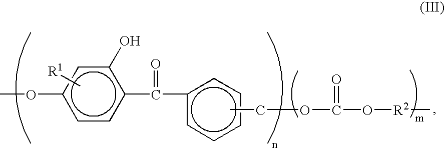
wherein R1, R2, m and n are as previously defined. It is also contemplated to introduce moieties of formula III via synthesis and polymerization.

The blend compositions of the invention may be prepared by such conventional operations as solvent blending and melt blending as by extrusion. They may additionally contain art-recognized additives including pigments, dyes, impact modifiers, stabilizers, flow aids and mold release agents. It is intended that the blend compositions include simple physical blends and any reaction products thereof, as illustrated by polyester-polycarbonate transesterification products.

Proportions of the block copolyestercarbonates in such blends are determined chiefly by the resulting proportions of arylate blocks, which are the active weatherability-improving entities, typical proportions providing about 10-50% by weight of arylate blocks in the blend. By reason of some degree of incompatibility between the block copolyestercarbonates of the invention and the polycarbonates and polyesters in which they may be incorporated, said blends are often not transparent. However, transparent blends may be prepared by adjusting the length of the arylate blocks in the block copolyestercarbonates. The other properties of said blends are excellent.

The block copolyestercarbonates of the invention, and blends thereof, may be used in various applications, especially those involving outdoor use and storage and hence requiring resistance to weathering. These include automotive body panels and trim; outdoor vehicles and devices such as lawn mowers, garden tractors and outdoor tools; lighting appliances; and enclosures for electrical and telecommunications systems.

In another embodiment the composition will have a percent transmittance of greater than or equal to about 70% and a glass transition temperature (Tg) of greater than or equal to about 150° C.

According to an embodiment, additional ingredients in the resin formulation may enhance processing, and thermal, and color stability of the resin formulation.

According to an embodiment, such additional ingredients may include polymeric ionomers. Examples of suitable polymeric ionomers (hereinafter ionomers) are polymers having moieties selected from the group consisting of sulfonate, phosphonate, and mixtures comprising at least one of the foregoing. Ionomers may be a reaction product of a metal base and the sulfonated and/or phosphonated polymer.

According to an embodiment, polyester ionomers have the following structure: 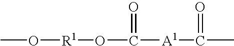
wherein each R1 is typically a divalent aliphatic, alicyclic or aromatic hydrocarbon or polyoxyalkylene radical, or mixtures thereof and each A1 is independently a divalent aliphatic, alicyclic or aromatic radical, or mixtures thereof. According to an embodiment, a portion of the polyester ionomer include R1 as cycloaliphatic units of CHDM-based polyesters. R1 consists of 10-100 mol % of CHDM. The remainder of the R1 units may be derived from individual or mixtures of any C2-C12 aliphatic, cycloaliphatic, aromatic hydrocarbon, or polyoxyalkylene glycols including, but not limited to ethylene glycol, 1,3-propane glycol, 1,2-propanediol, 2,4-dimethyl-2ethylhexane-1,3-diol, 2,2-dimethyl-1,3-propanediol, 2-ethyl-2-butyl-1,3-propanediol, 2-ethyl-2-isobutyl-1,3-propanediol, 1,3-butanediol, 1,4-butanediol, neopentylglycol, 1,5-pentanediol, 1,6-hexanediol, 1,8-octanediol, 2,2,4-trimethyl-1,6-hexanediol, 1,2-cyclohexanedimethanol, 1,3-cyclohexanedimethanol, 1,4-benzenedimethanol, diethyleneglycol, thiodiethanol, 2,2,4,4-tetramethyl-1,3-cyclobutanediol, etc.

According to an embodiment, 1-30 mol % of the A1 units are comprised of sulfonated aromatic radicals: 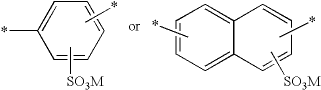
where M can be any mono- or di- or tri-valant cation including but not limited to Li, Na, K, Mg, Ca, Zn, Cu, Fe, NH4, tetraalkylammoniums (Me4N, Et4N, Pr4N, Bu4N) or tetraalkylphosphonium (Bu₄P). The range of sulfoacids as described in U.S. Pat. No. 3,779,993 are included as a reference and should be included in the scope of this invention as well.

The remainder of the A1 units can be derived from other diacids including succinic, glutaric, adipic, azelaic, sebacic, fumaric, maleic, itaconic, benzene dicarboxylic (including phthalic, isophthalic, terephthalic), naphthalene dicarboxylic, and cyclohexane dicarboxylic acids. Mixtures of these diacid units may also be used. Both the sulfonated and non-sulfonated A1 units may be derived from either diacids or diester compounds. The most typical diester used in the manufacture of these copolyesters is a dimethyl ester, such as dimethyl terephthalate, but any aliphatic, alicyclic or aromatic diester could be used. Suitable ionomers have at least about 1, preferably at least about 25, most preferably at least about 50 mol % of the sulfonate and/or phosphonate moieties of the ionomer present in an ionic form. Also at most about 99, preferably at most about 75, most preferably at most about 60 mol % of the sulfonate and/or phosphonate moieties of the ionomer are present in an ionic form.

In one embodiment, the polyesters ionomer copolymer are those derived from poly(ethylene terephthalate) (PET), and poly(1,4-butylene terephthalate) (PBT), and poly(1,3-propylene terephthalate), (PPT).

In one embodiment, the polyester ionomer copolymer has the structure depicted in structural formula 4 below: 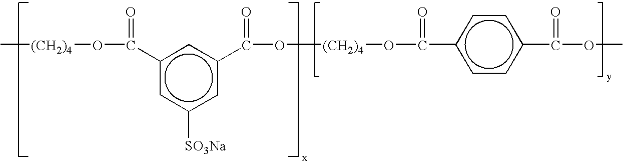
where the ionomer units, x, are from 0.1-20 mole % and the end-groups consist essentially of carboxylic acid (—COOH) end-groups and hydroxyl (—OH) end-groups. Polyester ionomers are desirable as compatibilizers in blends.

According to an embodiment, such additional ingredients may include multifunctional epoxies. In one embodiment the stabilized composition of the present invention may optionally comprise at least one epoxy-functional polymer. One epoxy polymer is an epoxy functional (alkyl)acrylic monomer and at least one non-functional styrenic and/or (alkyl)acrylic monomer. In one embodiment, the epoxy polymer has at least one epoxy-functional (meth)acrylic monomer and at least one non-functional styrenic and/or (meth)acrylic monomer which are characterized by relatively low molecular weights. In another embodiment the epoxy functional polymer may be epoxy-functional styrene(meth)acrylic copolymers produced from monomers of at least one epoxy functional (meth)acrylic monomer and at least one non-functional styrenic and/or (meth)acrylic monomer. As used herein, the term (meth)acrylic includes both acrylic and methacrylic monomers. Non limiting examples of epoxy-functional (meth)acrylic monomers include both acrylates and methacrylates. Examples of these monomers include, but are not limited to, those containing 1,2-epoxy groups such as glycidyl acrylate and glycidyl methacrylate. Other suitable epoxy-functional monomers include allyl glycidyl ether, glycidyl ethacrylate, and glycidyl itoconate.

Epoxy functional materials suitable for use as the compatibilizing agent in the subject resin blends contain aliphatic or cycloaliphatic epoxy or polyepoxy functionalization. Generally, epoxy functional materials suitable for use herein are derived by the reaction of an epoxidizing agent, such as peracetic acid, and an aliphatic or cycloaliphatic point of unsaturation in a molecule. Other functionalities which will not interfere with an epoxidizing action of the epoxidizing agent may also be present in the molecule, for example, esters, ethers, hydroxy, ketones, halogens, aromatic rings, etc. A well known class of epoxy functionalized materials are glycidyl ethers of aliphatic or cycloaliphatic alcohols or aromatic phenols. The alcohols or phenols may have more than one hydroxyl group. Suitable glycidyl ethers may be produced by the reaction of, for example, monophenols or diphenols described in Formula I such as bisphenol-A with epichlorohydrin. Polymeric aliphatic epoxides might include, for example, copolymers of glycidyl methacrylate or allyl glycidyl ether with methyl methacrylate, styrene, acrylic esters or acrylonitrile.

Specifically, the epoxies that can be employed herein include glycidol, bisphenol-A diglycidyl ether, tetrabromobisphenol-A diglycidyl ether, diglycidyl ester of phthalic acid, diglycidyl ester of hexahydrophthalic acid, epoxidized soybean oil, butadiene diepoxide, tetraphenylethylene epoxide, dicyclopentadiene dioxide, vinylcyclohexene dioxide, bis(3,4-epoxy-6-methylcyclohexylmethyl)adipate, and 3,4-epoxycyclohexylmethyl-3,4-epoxycyclohexane carboxylate.

Epoxy functionalized materials are available from Dow Chemical Company under the trade name DER-332, from Resolution Performance Products under the trade name EPON Resin 1001F, 1004F, 1005F, 1007F and 1009F; from Shell Oil Corporation under the trade names Epon 826, 828 and 871; from Ciba-Giegy Corporation under the trade names CY-182 and CY-183 and from DOW under the trade name ERL-4221 and ERL-4299. As set forth in the Examples, Johnson Polymer Co. is a supplier of an epoxy functionalized material known as ADR4368 and 4300.

The epoxy functionalized materials are added to the thermoplastic blend in amounts effective to improve compatibility as evidenced by both visual and measured physical properties associated with compatibility. A person skilled in the art may determine the optimum amount for any given epoxy functionalized material. Generally, from about 0.01 to about 10.0 weight parts of the epoxy functional material should be added to the thermoplastic blend for each 100 weight parts thermoplastic resin. Preferably, from about 0.05 weight parts to about 5.0 weight parts epoxy functional material should be added.

In addition to other common and suitable thermoplastic resins, the thermoplastic blends herein may contain additional ingredients as described in the following paragraphs.

According to an embodiment, such additional ingredients may include reactive oxazoline compounds, which are also known as cyclic imino ether compounds. Such compounds are described in Van Benthem, Rudolfus A. T. et al., U.S. Pat. No. 6,660,869 or in Nakata, Yoshitomo et al., U.S. Pat. No. 6,100,366. Examples of such compounds are phenylene bisoxazolines, 1,3-PBO, 1,4-PBO, 1,2-naphthalene bisoxazoline, 1,8-naphthalene bisoxazoline, 1,1 1-dimethyl-1, 3-PBO and 1,1 1-dimethyl-1,4-PBO.

In another embodiment, the reactive ingredients can be oligomeric copolymer of vinyl oxazoline and acrylic monomers. Specific examples of preferable oxazoline monomers include 2-vinyl-2-oxazoline, 5-methyl-2-vinyl-2-oxazoline, 4,4-dimethyl-2-vinyl-2-oxazoline, 4,4-dimethyl-2-vinyl-5,5-dihydro-4H-1,3-oxazoline, 2-isopropenyl-2-oxazoline, and 4,4-dimethyl-2-isopropenyl-2-oxazoline. Particularly, 2-isopropenyl-2-oxazoline and 4,4-dimethyl-2-isopropenyl-2-oxazoline are preferable, because they show good copolymerizability. The monomer component may further include other monomers copolymerizable with the cyclic imino ether group containing monomer. Examples of such other monomers include unsaturated alkyl carboxyl ate monomers, aromatic vinyl monomers, and vinyl cyanide monomers. These other monomers may be used either alone respectively or in combinations with each other. Examples of the unsaturated alkyl carboxylate monomer include methyl(meth)acrylate, ethyl(meth)acrylate, propyl(meth)acrylate, n-butyl(meth)acrylate, iso-butyl(meth)acrylate, t-butyl(meth)acrylate, 2-ethylhexyl(meth)acrylate, n-octyl(meth)acrylate, iso-nonyl(meth)acrylate, dodecyl(meth)acrylate, and stearyl(meth)acrylate, styrene and α-methyl styrene.

Suppliers of oxazoline functionalized materials include Nippon Shokubai company, under the trade name Epocross and 1,4-BPO from DSM Chemicals and 1,3-BPO from Takeda Chemicals. These types of functionalized materials are described in U.S. Pat. No. 4,590,241 to Hohfeld.

The compositions of the invention may further comprise additional additives such suitable dyes, pigments, and special effects additives as is known in the art, as well as mold release agents, antioxidants, lubricants, nucleating agents such as talc and the like, other stabilizers including but not limited to UV stabilizers, such as benzotriazole, supplemental reinforcing fillers, and the like, flame retardants, pigments or combinations thereof.

In another embodiment, the immiscible ITR polymer includes a polycarbonate polymer which is miscible with the ITR polymer. The polycarbonate polymer may be added to aid in adjusting the index of refraction of the ITR polymer phase to match the index of refraction of the ITR polymer phase. “Polycarbonate” and/or “polycarbonate composition” includes compositions having structural units of formula 5: 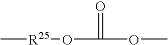
wherein R25 is aromatic organic radicals and/or aliphatic, alicyclic, or heteroaromatic radicals. Preferably, R25 is an aromatic organic radical and, more preferably, a radical having the formula -A1-Y1-A2- wherein each of A1 and A2 is a monocyclic divalent aryl radical and Y1 is a bridging radical having one or more atoms which separate A1 from A2. In an exemplary embodiment, one atom separates A1 from A2. Illustrative non-limiting examples of radicals of this type include: —O—, —S—, —S(O)—, —S(O2)-, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, adamantylidene, and the like. The bridging radical Y1 can be a hydrocarbon group or a saturated hydrocarbon group such as methylene, cyclohexylidene, or isopropylidene.

Suitable polycarbonates can be produced by the interfacial reaction of dihydroxy compounds in which only one atom separates A1 and A2. As used herein, the term “dihydroxy compound” includes, for example, bisphenol compounds having generally formula 6: 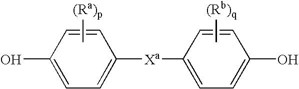
wherein Ra and Rb each represent a halogen atom or a monovalent hydrocarbon group and may be the same or different; p and q are each independently integers from 0 to 4; and Xa is one of the groups of formula 7: 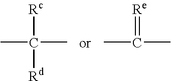
wherein Rc and Rd each independently represent a hydrogen atom or a monovalent linear or cyclic hydrocarbon group and Re is a divalent hydrocarbon group.

Some illustrative, non-limiting examples of suitable dihydroxy compounds include the dihydroxy-substituted aromatic hydrocarbons disclosed by name or formula (generic or specific) in U.S. Pat. No. 4,217,438. A nonexclusive list of specific examples of the types of bisphenol compounds represented by formula 11 includes: 1,1-bis(4-hydroxyphenyl)methane; 1,1-bis(4-hydroxyphenyl)ethane; 2,2-bis(4-hydroxyphenyl)propane (hereinafter “bisphenol A” or “BPA”); 2,2-bis(4-hydroxyphenyl)butane; 2,2-bis(4-hydroxyphenyl)octane; 1,1-bis(4-hydroxyphenyl)propane; 1,1-bis(4-hydroxyphenyl) n-butane; bis(4-hydroxyphenyl)phenylmethane; 2,2-bis(4-hydroxy-1-methylphenyl)propane; 1,1-bis(4-hydroxy-t-butylphenyl)propane; bis(hydroxyaryl)alkanes such as 2,2-bis(4-hydroxy-3-bromophenyl)propane; 1,1-bis(4-hydroxyphenyl)cyclopentane; and bis(hydroxyaryl)cycloalkanes such as 1,1-bis(4-hydroxyphenyl)cyclohexane.

Two or more different dihydric phenols or a copolymer of a dihydric phenol with a glycol or with a hydroxy (—OH) or acid-terminated polyester may be employed, or with a dibasic acid or hydroxy acid, in the event a carbonate copolymer rather than a homopolymer may be desired for use. Polyarylates and polyester-carbonate resins or their blends can also be employed. Branched polycarbonates are also useful, as well as blends of linear polycarbonate and a branched polycarbonate. The branched polycarbonates may be prepared by adding a branching agent during polymerization.

Suitable branching agents include polyfunctional organic compounds containing at least three functional groups, which may be hydroxyl, carboxyl, carboxylic anhydride, haloformyl, and mixtures thereof. Examples include, but are not limited to trimellitic acid, trimellitic anhydride, trimellitic trichloride, tris-p-hydroxy phenyl ethane, isatin-bis-phenol, 1,3,5-tris((p-hydroxyphenyl)isopropyl)benzene, 4(4(1,1-bis(p-hydroxyphenyl)-ethyl, alpha,alpha-dimethyl benzyl)phenol, 4-chloroformyl phthalic anhydride, trimesic acid and benzophenone tetracarboxylic acid. Branching agents may be added at a level greater than about 0.05%. The branching agents may also be added at a level less than about 2.0% by weight of the total. Branching agents and procedures for making branched polycarbonates are described in U.S. Pat. No. 3,635,895 to Kramer, and U.S. Pat. No. 4,001,184 to Scott.

Preferred polycarbonates are based on bisphenol A, in which each of A1 and A2 of Formula 9 is p-phenylene and Y1 is isopropylidene. The average molecular weight of the polycarbonate is greater than about 5,000, preferably greater than about 10,000, most preferably greater than about 15,000. In addition, the average molecular weight is less than about 100,000, preferably less than about 65,000, most preferably less than about 45,000 g/mol.

In another embodiment, the composition of the invention includes additionally, one or more polyesters. Suitable polyesters include those derived from an aliphatic, cycloaliphatic, or aromatic diol, or mixtures thereof, containing from 2 to about 10 carbon atoms and at least one aromatic dicarboxylic acid. Preferred polyesters are derived from an aliphatic diol and an aromatic dicarboxylic acid having repeating units of the following general formula 8: 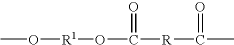
wherein R1 is an C6-C20 alkyl, or aryl radical, and R is a C6-C20 alkyl or aryl radical comprising a decarboxylated residue derived from an alkyl or aromatic dicarboxylic acid.

Examples of aromatic dicarboxylic acids represented by the decarboxylated residue R are isophthalic or terephthalic acid, 1,2-di(p-carboxyphenyl)ethane, 4,4′-dicarboxydiphenyl ether, 4,4′ bisbenzoic acid, and mixtures thereof. These acids contain at least one aromatic nucleus. Acids containing fused rings can also be present, such as in 1,4-1,5- or 2,6-naphthalene dicarboxylic acids. The preferred dicarboxylic acids are terephthalic acid, isophthalic acid, naphthalene dicarboxylic acid or a mixture thereof.

The diol may be a glycol, such as ethylene glycol, propylene glycol, trimethylene glycol, 2-methyl-1,3-propane glycol, hexamethylene glycol, decamethylene glycol, cyclohexane dimethanol, or neopentylene glycol; or a diol such as 1,4-butanediol, hydroquinone, or resorcinol.

Also contemplated herein are the above polyesters with minor amounts, e.g., from about 0.5 to about 30 percent by weight, of units derived from aliphatic acids and/or aliphatic polyols to form copolyesters. The aliphatic polyols include glycols, such as poly(ethylene glycol). Such polyesters can be made following the teachings of, for example, U.S. Pat. Nos. 2,465,319 and 3,047,539.

The most preferred polyesters are poly(ethylene terephthalate) (“PET”), poly(1,4-butylene terephthalate), (“PBT”), and poly(propylene terephthalate) (“PPT”). One preferred a preferred PBT resin is one obtained by polymerizing a glycol component at least 70 mole %, preferably at least 80 mole %, of which consists of tetramethylene glycol and an acid component at least 70 mole %, preferably at least 80 mole %, of which consists of terephthalic acid, and polyester-forming derivatives therefore. The preferred glycol component can contain not more than 30 mole %, preferably not more than 20 mole %, of another glycol, such as ethylene glycol, trimethylene glycol, 2-methyl-1,3-propane glycol, hexamethylene glycol, decamethylene glycol, cyclohexane dimethanol, or neopentylene glycol. The preferred acid component can contain not more than 30 mole %, preferably not more than 20 mole %, of another acid such as isophthalic acid, 2,6-naphthalene dicarboxylic acid, 2,7-naphthalene dicarboxylic acid, 1,5-naphthalene dicarboxylic acid, 4,4′-diphenyl dicarboxylic acid, 4,4′-diphenoxyethane dicarboxylic acid, p-hydroxy benzoic acid, sebacic acid, adipic acid and polyester-forming derivatives thereof.

Block copolyester resin components are also useful, and can be prepared by the transesterification of (a) straight or branched chain poly(1,4-butylene terephthalate) and (b) a copolyester of a linear aliphatic dicarboxylic acid and, optionally, an aromatic dibasic acid such as terephthalic or isophthalic acid with one or more straight or branched chain dihydric aliphatic glycols. For example a poly(1,4-butylene terephthalate) can be mixed with a polyester of adipic acid with ethylene glycol, and the mixture heated at 235° C. to melt the ingredients, then heated further under a vacuum until the formation of the block copolyester is complete. As the second component, there can be substituted poly(neopentyl adipate), poly(1,6-hexylene azelate-coisophthalate), poly(1,6-hexylene adipate-co-isophthalate) and the like. An exemplary block copolyester of this type is available commercially from General Electric Company, Pittsfield, Mass., under the trade designation VALOX 330.

Especially useful when high melt strength is important are branched high melt viscosity poly(1,4-butylene terephthalate) resins, which include a small amount of e.g., up to 5 mole percent based on the terephthalate units, of a branching component containing at least three ester forming groups. The branching component can be one which provides branching in the acid unit portion of the polyester, or in the glycol unit portion, or it can be hybrid. Illustrative of such branching components are tri- or tetracarboxylic acids, such as trimesic acid, pyromellitic acid, and lower alkyl esters thereof, and the like, or preferably, polyols, and especially preferably, tetrols, such as pentaerythritol, triols, such as trimethylolpropane; or dihydroxy carboxylic acids and hydroxydicarboxylic acids and derivatives, such as dimethyl hydroxyterephthalate, and the like. The branched poly(1,4-butylene terephthalate) resins and their preparation are described in Borman, U.S. Pat. No. 3,953,404, incorporated herein by reference.

In addition to terephthalic acid units, small amounts, e.g., from 0.5 to 15 percent by weight of other aromatic dicarboxylic acids, such as isophthalic acid or naphthalene dicarboxylic acid, or aliphatic dicarboxylic acids, such as adipic acid, can also be present, as well as a minor amount of diol component other than that derived from 1,4-butanediol, such as ethylene glycol or cyclohexylenedimethanol, etc., as well as minor amounts of trifunctional, or higher, branching components, e.g., pentaerythritol, trimethyl trimesate, and the like. In addition, the poly(1,4-butylene terephthalate) resin component can also include other high molecular weight resins, in minor amount, such as poly(ethylene terephthalate), block copolyesters of poly(1,4-butylene terephthalate) and aliphatic/aromatic polyesters, and the like. The molecular weight of the poly(1,4-butylene terephthalate) should be sufficiently high to provide an intrinsic viscosity of about 0.6 to 2.0 deciliters per gram(dl/g), preferably 0.8 to 1.6 dl/g, measured, for example, as a solution in a 60:40 mixture of phenol and tetrachloroethane at 30° C.

Preferred aromatic carbonates are homopolymers, for example, a homopolymer derived from 2,2-bis(4-hydroxyphenyl)propane (bisphenol-A) and phosgene, commercially available under the trade designation LEXAN™ from General Electric Company. When polycarbonate is used, the polyester resin blend component of the composition comprises about 5 to about 50 percent by weight of polycarbonate, and 95 to 50 percent by weight of polyester resin, based on the total weight of the polyester blend component.

The polyester resin blend component may further optionally comprise impact modifiers such as a rubbery impact modifier. Typical impact modifiers are derived from one or more monomers selected from the group consisting of olefins, vinyl aromatic monomers, acrylic and alkyl acrylic acids and their ester derivatives, as well as conjugated dienes. Especially preferred impact modifiers are the rubbery, high-molecular weight materials including natural and synthetic polymeric materials showing elasticity at room temperature. They include both homopolymers and copolymers, including random, block, radial block, graft and core-shell copolymers, as well as combinations thereof. Suitable modifiers include core-shell polymers built up from a rubber-like core on which one or more shells have been grafted. The core typically consists substantially of an acrylate rubber or a butadiene rubber. One or more shells typically are grafted on the core. The shell preferably comprises a vinyl aromatic compound and/or a vinyl cyanide and/or an alkyl(meth)acrylate. The core and/or the shell(s) often comprise multi-functional compounds which may act as a cross-linking agent and/or as a grafting agent. These polymers are usually prepared in several stages.

The resin may include various additives incorporated in the resin. Such additives include, for example, fillers, reinforcing agents, heat stabilizers, antioxidants, plasticizers, antistatic agents, mold releasing agents, additional resins, blowing agents, and the like, such additional additives being readily determined by those of skill in the art without undue experimentation. Examples of fillers or reinforcing agents include glass fibers, asbestos, carbon fibers, silica, talc, and calcium carbonate. Examples of heat stabilizers include triphenyl phosphite, tris-(2,6-dimethylphenyl)phosphite, tris-(mixed mono-and di-nonylphenyl)phosphite, and dimethylbenene phosphonate and trimethyl phosphate. Examples of antioxidants include octadecyl-3-(3,5-di-tert-butyl-4-hydroxyphenyl)propionate, and pentaerythrityl-tetrakis[3-(3,5-di-tert-butyl-4-hydroxyphenyl)propionate]. Examples of plasticizers include dioctyl-4,5-epoxy-hexahydrophthalate, tris-(octoxycarbonylethyl)isocyanurate, tristearin, and epoxidized soybean oil. Examples of antistatic agents include glycerol monostearate, sodium stearyl sulfonate, and sodium dodecylbenzenesulfonate. Examples of mold releasing agents include stearyl stearate, beeswax, montan wax, and paraffin wax. Examples of other resins include but are not limited to polypropylene, polystyrene, polymethyl methacrylate, and polyphenylene oxide. Individual, as well as combinations of the foregoing may be used. Such additives may be mixed at a suitable time during the mixing of the components for forming the composition.

The weatherable compositions are suitable for a wide variety of uses, for example in automotive applications such as body panels, cladding, and mirror housings; in recreational vehicles including such as golf carts, boats, and jet skies; and in applications for building and construction, including, for example, outdoor signs, ornaments, and exterior siding for buildings. The final articles can be formed by compression molding, multiplayer blow molding, coextrusion of sheet or film, injection over molding, insertion blow molding and other methods.

From an aesthetic standpoint, the use of color pigments for special visual effects may be utilized. Such ingredients may include a metallic-effect pigment, a metal oxide-coated metal pigment, a platelike graphite pigment, a platelike molybdenumdisulfide pigment, a pearlescent mica pigment, a metal oxide-coated mica pigment, an organic effect pigment a layered light interference pigment, a polymeric holographic pigment or a liquid crystal interference pigment. Preferably, the effect pigment is a metal effect pigment selected from the group consisting of aluminum, gold, brass and copper metal effect pigments; especially aluminum metal effect pigments. Alternatively, preferred effect pigments are pearlescent mica pigments or a large particle size, preferably platelet type, organic effect pigment selected from the group consisting of copper phthalocyanine blue, copper phthalocyanine green, carbazole dioxazine, diketopyrrolopyrrole, iminoisoindoline, irninoisoindolinone, azo and quinacridone effect pigments.

Suitable colored pigments may be included in the resin blend. Such pigments include organic pigments selected from the group consisting of azo, azomethine, methine, anthraquinone, phthalocyanine, perinone, perylene, diketopyrrolopyrrole, thioindigo, dioxazine iminoisoindoline, dioxazine, iminoisoindolinone, quinacridone, flavanthrone, indanthrone, anthrapyrimidine and quinophthalone pigments, or a mixture or solid solution thereof; especially a dioxazine, diketopyrrolopyrrole, quinacridone, phthalocyanine, indanthrone or iminoisoindolinone pigment, or a mixture or solid solution thereof.

Colored organic pigments of particular interest include C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 109, C.I. Pigment Yellow 110, C.I. Pigment Yellow 147, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 37, C.I. Pigment Violet 19, C.I. Pigment Green 7, C.I. Pigment Green 36, or a mixture or solid solution thereof.

Suitable colored pigments also include inorganic pigments; especially those selected from the group consisting of metal oxides, antimony yellow, lead chromate, lead chromate sulfate, lead molybdate, ultramarine blue, cobalt blue, manganese blue, chrome oxide green, hydrated chrome oxide green, cobalt green and metal sulfides, such as cerium or cadmium sulfide, cadmium sulfoselenides, zinc ferrite, bismuth vanadate and mixed metal oxides.

Most preferably, the colored pigment is a transparent organic pigment. Pigment compositions wherein the colored pigment is a transparent organic pigment having a particle size range of below 0.2 μm, preferably below 0.1 μm, are particularly interesting. For example, inventive pigment compositions containing, as transparent organic pigment, the transparent quinacridones in their magenta and red colors, the transparent yellow pigments, like the isoindolinones or the yellow quinacridone/quinacridonequinone solid solutions, transparent copper phthalocyanine blue and halogenated copper phthalocyanine green, or the highly-saturated transparent diketopyrrolopyrrole or dioxazine pigments are particularly interesting.

Typically the pigment composition is prepared by blending the pigment with the filler by known dry or wet mixing techniques. For example, the components are wet mixed in the end step of a pigment preparatory process, or by blending the filler into an aqueous pigment slurry, the slurry mixture is then filtered, dried and micropulverized.

In a preferred method, the pigment is dry blended with the filler in any suitable device which yields a nearly homogenous mixture of the pigment and the filler. Such devices are, for example, containers like flasks or drums which are submitted to rolling or shaking, or specific blending equipment like for example the TURBULA mixer from W. Bachofen, CH-4002 Basel, or the P-K TWIN-SHELL INTENSIFIER BLENDER from Patterson-Kelley Division, East Stroudsburg, Pa. 18301. The pigment compositions are generally used in the form of a powder which is incorporated into a high-molecular-weight organic composition, such as a coating composition, to be pigmented. The pigment composition consists of or consists essentially of the filler and colored pigment, as well as customary additives for pigment compositions. Such customary additives include texture-improving agents and/or antiflocculating agents.

The ingredients of the examples shown below in Tables, were tumble blended and then extruded on a 30 mm Werner Pfleiderer Twin Screw Extruder with a vacuum vented mixing screw, at a barrel and die head temperature between 260-280° C. and 300 rpm screw speed. The extrudate was cooled through a water bath prior to pelletizing. Test parts were injection molded on a van Dorn molding machine with a set temperature of approximately 260-280° C. The pellets were dried under vacuum overnight prior to injection molding.

Tensile elongation at break was tested on 7×⅛ in. injection molded bars at room temperature with a crosshead speed of 2 in./min. using ASTM method D648. Notched Izod testing was done on 3×½×⅛ inch bars using ASTM method D256.

Chemical resistance tests were performed on ISO tensile bars using the Berg-n-jig method at 0, 0.5 or 1% strain for periods of 24, 48 or 64 hours. Chemicals used for testing are as follows:
1. Fuel C: 42.5% toluene, 15% methanol
2. Carolina Herrera (Eau de parfum)—http://www.carolinaherrera.com/home.htm
3. Coppertone 30—Coppertone Moisturizing Sunblock with Avobenzone
4. Gasoline—Amoco Octane 87
5. 80% Ethanol—by volume in de-ionized water
6. Skydrol 500 B-4 aviation hydraulic fluid from Solutia Inc.
7. 70% IPA—CVS Isopropyl rubbing alcohol (16 oz.)
8. Cascade (from Proctor & Gamble): 10% solution made in water
9. Nivea cream—http://www.beiersdorf.com/Area_Brands/Core Brands/NIVEA/Brand History.as px
10. Hugo BOSS perfume—http://www.hugoboss.com/select.html

The optical measurements such as % transmission, haze and yellowing index (YI) were run on Gretag Macbeth CE 7000, running Optiview Propallette software. YI was measured according to ASTM E313-73, Correlated Haze was measured using CIE Lab, Illum C@10°, % T was run using test method CIE_{—}1931 (XYZ) and measured in CIE Lab, Illum C at 2°.

Biaxial impact testing, sometimes referred to as instrumented impact testing, was done as per ASTM D3763 using a 4×⅛ inch molded discs. The total energy absorbed by the sample is reported as ft-lbs. Testing was done at room temperature on as molded or as weathered samples.

Accelerated weathering test was done as per ASTM-G26. The samples of 2×3×⅛ inch molded rectangular specimen, “color chip”, were subjected to light in xenon arc weatherometer equipped with borosilicate inner and outer filters at an irradiance of 0.35 W/m2 at 340 nm, using cycles of 90 min light and 30 min dark with water spray. The humidity and temperature were kept at 60% and 70oC, respectively.

Chip color was measured on a ACS CS-5 ChromoSensor in reflectance mode with a D65 illuminant source, a 10 degree observer, specular component included, CIE color scale as described in “Principles of Color Technology” F. W. Billmeyer and M. Saltzman/John Wiley & Sons, 1966. The instrument was calibrated immediately prior to sample analysis against a standard white tile. The color values reported below are the difference before and after UV exposure. The color change is expressed as delta E. Testing was done as per ASTM D2244.

Delaminator was checked using a 4 inch disk with a cylindrical sprue with a diameter of about 0.25″. To check the delamination properties, the sprue was forced to break from the disk. Parts with no delamination showed failure at the interface between the sprue and disk without further cracks in the disk. In contrast, delaminated parts displayed cracks into the disk and the surface layers of the disk can be easily peeled off from the bulk around the cracks. At least 5 disks were molded to check delamination properties.

TABLE 1
shows the ingredients used in the blends discussed in
the comparative examples (designated by letters) and the
examples of the invention (designated by numbers).

| Abbreviation | Material |
|---|---|
| PC | PCP (para-cumyl phenol) capped polycarbonate |
| | (synthesized from Bisphenol-A and phosgene) . . . |
| | Mw: 17,000-37,000, Refractive index = 1.58 |
| ITR-20 | Block copolyestercarbonate of 80% polycarbonate |
| | and 20% thermoplastic arylate polymer (wherein |
| | arylate units are synthesized from resorcinol |
| | and ratios of isophthalic and terephthalic acid |
| | chlorides or esters), refractive index = 1.592. |
| ITR-60 | Block copolyestercarbonate of 40% polycarbonate |
| | and 60% thermoplastic arylate polymer (wherein |
| | arylate units are synthesized from resorcinol |
| | and ratios of isophthalic and terephthalic acid |
| | chlorides or esters), refractive index = 1.608 |
| Selar | Copolymer of hexamethylene diamine with isopthalic |
| | acid and terepthalic acid sold as Selar3426 from |
| | Dupont Co.. Mw˜20,000 gm/mol, refractive |
| | index = 1.592 |
| GTR45 | Copolymer of hexamethylene diamine with isopthalic |
| | acid and terepthalic acid, Refractive index = 1.590 |
| 412S | Thioester, Pentaerythritol |
| | tetrakis(3-(dodecylthio)propionate) sold as SEENOX |
| | 412-S from Crompton |
| AO1010 | Hindered Phenol, Pentaerythritol |
| | tetrakis(3,5-di-tert-butyl-4-hydroxyhydrocinnamate) |
| | sold as IRAGANOX 1010 from Ciba Geigy |
| AO168 | Phosphite, 2,4-di-tert-butylphenol phosphite (3:1) |
| | sold as IRGAPHOS 168 from Ciba Geigy |
| ERL4221 | 3,4-epoxycyclohexylmethyl-3-4-epoxy-cyclohexyl |
| | carboxylate from Union Carbide Co. |
| ADR4368 | Copolymer of styrene and glycidylmethacrylate from |
| | Johnson Polymer Co. Mw˜6800 g/mol. Multifunctional |
| | epoxide. |
| ADR4300 | Copolymer of styrene and glycidylmethacrylate from |
| | Johnson Polymer Co. Mw˜6800 g/mol. Multifunctional |
| | epoxide. |
| ADR4310 | An epoxy functional additive that is useful as a |
| | disperant for polar materials. Can improve adhesion to |
| | metals. Useful as a reactant in specialty applications. |
| Epocros RPS- | Polystyrene with pendant oxazoline groups (95% styrene, |
| 1005 | 5% oxazoline)˜Mw 180,000 |
| Epocros RAS | Styrene-acrylonitrile copolymer with pendant oxazoline |
| | groups (70% styrene, 25% acrylonitrile, 5% |
| | oxazoline) . . . ˜Mw 60,000 |
| PETS | pentaerythritol tetrastearate |
| Seenox 412S | Thioester, Pentaerythritol tetrakis |
| | (3-(dodecylthio)propionate) sold from Crompton. |

### EXAMPLES A-B & 1-11

As examples of chemical resistance, the blends shown in Table 2a were extruded, molded, and tested. Surprisingly, the blends of the polyamide and block copolyestercarbonate have chemical resistance superior to that found for either Selar or block copolyestercarbonate. The results on ESCR measurements at different blend ratios are also shown in the Table 2a below. From the data we not only see synergies in chemical resistance but also the blends both in the case of Selar and GTR-45 show excellent transparency with ITR20 and ITR20-PC blends respectively.

TABLE 2a
Summary of physical, ESCR and optical properties of the Selar/ITR20 blends.
All chemical resistance Berg-n-jig tests performed at 1% strain over 48 hours.

| | | | | | | | | | | |
|---|---|---|---|---|---|---|---|---|---|---|
| Ingredient | A | B | C | 1 | 2 | 3 | 4 | 5 | 6 | 7 |

Comparative examples and examples of the invention

| | | | | | | | | | | |
|---|---|---|---|---|---|---|---|---|---|---|
| Selar | 100 | | | 63 | 63 | 63 | 63 | 50 | 50 | |
| GTR45 | | | 100 | | | | | | | 50 |
| ITR20 | | 100 | | 37 | 37 | 37 | 37 | 50 | 48 | 32 |
| ITR60 | | | | | | | | | 2 | |
| PC-100 | | | | | | | | | | 18 |
| Heat | | | 0.35 | 0.35 | 0.35 | 0.35 | 0.35 | 0.35 | 0.35 | |
| stabilizers* | | | | | | | | | | |
| ADR 4368 | | | | 0.315 | | ? | ? | 0.25 | 0.25 | 0.5 |
| RPS | | | | | 0.25 | | | | | |
| RAS | | | | | | 0.25 | | | | |
| % | 89 | 84 | 89 | 81 | 87.5 | 87.5 | 85 | 85 | 84 | 81 |
| transmission | | | | | | | | | | |

Chemical Resistance

| | | | | | | | | | | |
|---|---|---|---|---|---|---|---|---|---|---|
| Ethanol | Big | No | Big | No | No | No | No | No | No | No |
| | cracks | cracks | cracks | cracks | cracks | cracks | cracks | cracks | cracks | cracks |
| Acetone | Big | Big | Big | No | No | No | — | No | No | — |
| | cracks | cracks | cracks | cracks | cracks | cracks | | cracks | cracks | |
| Coppertone | No | No | No | No | No | No | No | No | No | No |
| | cracks | cracks | cracks | cracks | cracks | cracks | cracks | cracks | cracks | cracks |
| Perfume | Big | Big | | No | No | No | | | | |
| (Hugo) | cracks | cracks | | cracks | cracks | cracks | | | | |
| Nivea | Big | Big | | No | — | — | No | | | |
| | cracks | cracks | | cracks | | | cracks | | | |
| Fuel C | No | Big | No | No | No | No | — | No | No | No |
| | cracks | cracks | cracks | cracks | cracks | cracks | | cracks | cracks | cracks |

Mechanical Properties

| | | | | | | | | | | |
|---|---|---|---|---|---|---|---|---|---|---|
| Tensile | 485000 | 360000 | 464000 | 452000 | 446000 | 445000 | 442000 | 459000 | 453000 | 428000 |
| Modulus (psi) | | | | | | | | | | |
| Tensile | 75 | 127 | 160 | 42 | 3.7 | 3.75 | 33.31 | 80 | 128 | 103 |
| Elongation at | | | | | | | | | | |
| break (%) | | | | | | | | | | |
| HDT (degree | 102.4 | 119 | 103.9 | 99.1 | 96.5 | 100.3 | 100 | 108 | | 104.2 |
| C.) | | | | | | | | | | |
| Flexural | 427000 | 365000 | 431000 | 411000 | 411000 | 410000 | 419000 | 403000 | 400000 | 408000 |
| Modulus (psi) | | | | | | | | | | |

Heat stabilizers: 0.2% Irgafos 168, 0.1% Irganox 1010, and 0.05% Seenox 412S

TABLE 2b
Summary of physical, ESCR and optical properties of the Selar/ITR20 blends. ESCR data includes
visual appearance and retention of mechanical properties (elongation at break)

| Ingredient | A | B | 8 | 9 | 10 | 11 |
|---|---|---|---|---|---|---|
| Selar | 100 | | 10 | 25 | 50 | 63 |
| ITR20 | | 100 | 90 | 75 | 50 | 37 |
| Heat stabilizers* | | | 0.35 | 0.35 | 0.35 | 0.35 |
| ADR 4368 | | | 0.25 | 0.25 | 0.25 | 0.25 |
| % transmission | 89 | 84 | 86.9 | 86.5 | 86.5 | 87.1 |

Chemical Resistance (elongation at break (%) given in parenthesis)

| | | | | | | |
|---|---|---|---|---|---|---|
| Gasoline (0% 64 hrs) | No | Big | No | No | No | No |
| | cracks (100) | cracks (8) | cracks (99) | cracks (100) | cracks (91) | cracks (100) |
| Windex (1% 64 hrs) | No | Big | No | No | No | No |
| | cracks (100) | cracks (0) | cracks (93) | cracks (98) | cracks (100) | cracks (97) |
| Skydroll (0% 24 hrs) | No | Big | Small | Small | No | No |
| | cracks (100) | cracks (9) | cracks (38) | cracks (29) | cracks (99) | cracks (96) |
| Perfume (0% 48 hrs) | No | Big | Small | No | No | No |
| | cracks (100) | cracks (18) | cracks (73) | cracks (99) | cracks (94) | cracks (96) |
| 70% IPA (1% 48 hrs) | Big | No | No | No | No | Big |
| | cracks (0) | cracks (100) | cracks (89) | cracks (97) | cracks (84) | cracks (0) |
| Cascade (1% 48 hrs) | Small | No | No | No | No | Small |
| | cracks (100) | cracks (100) | cracks (96) | cracks (100) | cracks (100) | cracks (99) |
| 80% Ethanol (1% 28 days) | Big | No | No | No | No | No |
| | cracks (0) | cracks (77) | cracks (94) | cracks (100) | cracks (100) | cracks (66) |
| Coppertone (1% 48 hrs) | No | No | No | No | No | No |
| | cracks (0) | cracks (79) | cracks (96) | cracks (100) | cracks (100) | cracks (100) |

Mechanical Properties

| | | | | | | |
|---|---|---|---|---|---|---|
| Tensile Modulus | 485000 | 360000 | 374000 | 398000 | 428000 | 440000 |
| (psi) | | | | | | |
| Tensile Elongation | 75 | 127 | 125 | 120 | 104 | 144 |
| at break (%) | | | | | | |
| HDT (degree C.) | 102.4 | 119 | 115.6 | 107.5 | 101.3 | 100 |
| Flexural Modulus | 427000 | 365000 | 368000 | 382000 | 402000 | 415000 |
| (psi) | | | | | | |

*Heat stabilizers: 0.2% Irgafos 168, 0.1% Irganox 1010, and 0.05% Seenox 412S
*Chemical resistance test were done at 0% strain for 24 hrs (0% 24 hrs) or at 1.0% strain for a given time.

### EXAMPLES D-E & 12-13

As examples of weathering, the blends shown in Table 3 were extruded, molded, and tested. Polyamide in sample C showed much lower weatherability than ITR20 in sample D. ITR20 showed better weatherability than polyamide in two aspects: low color shift at short time and reach to a plateau in color after 336 hrs. The poor weatherability of Polyamide was improved by adding ITR20 as shown in sample 12 and 13. The blend of Polyamide and block copolyestercarbonate shows similar weatherability to ITR20, showing plateau value after 336 hrs. In addition, the absolute value of the color shift at the plateau can be controlled by the ITR20 content.

Examples 1-4 demonstrated that the blend of Polyamide and block copolyestercarbonate showed excellent chemical resistance as well as excellent weatherability.

TABLE 3
ASTM G26 Weathering

| Ingredient | D | E | 12 | 13 |
|---|---|---|---|---|
| Selar | 100 | | 63 | 25 |
| ITR20 | | 100 | 37 | 75 |
| Heat stabilizers* | | | 0.35 | 0.35 |
| ADR 4368 | | | 0.315 | 0.315 |

Weathering resistance

| | | | | |
|---|---|---|---|---|
| DE after 168 hours | 3.4 | 1.8 | 2.7 | 0.9 |
| per ASTM G26 | | | | |
| DE after 336 hours | 5 | 2.1 | 4.2 | 2.6 |
| per ASTM G26 | | | | |
| DE after 504 hours | 5.7 | 2.2 | 4.3 | 2.6 |
| per ASTM G26 | | | | |
| DE after 672 hours | 7.3 | 2.6 | 4.5 | 3 |
| per ASTM G26 | | | | |
| DE after 1344 hours | 9.4 | 2.9 | 4.7 | 3.3 |
| per ASTM G26 | | | | |
| DE after 2016 hours | 10.3 | 3.3 | 4.9 | 4 |
| per ASTM G26 | | | | |

Mechanical properties

| | | | | |
|---|---|---|---|---|
| Tensile Modulus | 485000 | 360000 | 443000 | 398000 |
| Elongation at break | 75 | 127 | 86 | 120 |
| HDT | 102.4 | 119 | 99.7 | 108 |
| Flexural Modulus | 427000 | 365000 | 418000 | 382000 |

*Heat stabilizers: 0.2% Irgafos 168, 0.1% Irganox 1010, and 0.05% Seenox 412S

### EXAMPLES F-I & 14-18

As examples of rheology and color, the blends shown in Table 4 were extruded by a twin-screw extruder. Sample F without heat stabilizers resulted in dark yellow pellets that indicates low heat stability during the extrusion process. Sample F without stabilizers including epoxide and oxazoline showed unstable and uneven strand. Capillary viscosity of sample F is lower than that of both pure Polyamide, sample G, and pure ITR20, sample H, indicating that there is severe degradation in PC or Polyamide during the extrusion. The processibility was improved by using epoxide or oxazoline as shown in samples 14-18. Stable strand during extrusion and less degradation in capillary viscosity as compared to sample E was shown.

TABLE 4
Stabilizer effect on processability of Polyamide and block copolyestercarbonate blends

| Ingredient | F | G | H | I | 14 | 15 | 16 | 17 | 18 |
|---|---|---|---|---|---|---|---|---|---|
| Selar | 63 | 63 | 100 | — | 63 | 63 | 63 | 63 | 63 |
| ITR20 | 37 | 37 | — | 100 | 37 | 37 | 37 | 37 | 37 |
| Heat stabilizers* | — | 0.35 | — | — | 0.35 | 0.35 | 0.35 | 0.35 | 0.35 |
| ERL | — | — | — | — | 0.75 | — | — | — | — |
| ADR4368 | 0.25 | — | — | — | — | 0.375 | 0.5 | — | — |
| ADR4300 | — | — | — | — | — | — | — | 0.5 | — |
| RAS | — | — | — | — | — | — | — | — | 0.2 |
| Appearance of | Stable | Unstable | Stable | Stable | Stable | Stable | Stable | Stable | Stable |
| extrusion strand | strand | strand | strand | strand | strand | strand | strand | strand | strand |
| Color of strand | Dark | Transparent | Transparent | Transparent | Transparent | Transparent | Transparent | Transparent | Transparent |
| | yellow | light | light | light | light | light | light | light | light |
| | | yellow | yellow | yellow | yellow | yellow | yellow | yellow | yellow |
| Capillary shear | 918.3 | 157.8 | 459.1 | 1219 | 373.8 | 1033.1 | 1248.3 | 1650 | 588.3 |
| viscosity at 24 s-1 | | | | | | | | | |
| at 290 deg C. (Pa) | | | | | | | | | |
| Capillary shear | 533.6 | 134.9 | 439.1 | 947 | 309.9 | 582.5 | 714.6 | 740.4 | 444.8 |
| viscosity at 121 s-1 | | | | | | | | | |
| at 290 deg C. (Pa) | | | | | | | | | |
| Capillary shear | 249.5 | 99.7 | 250.9 | 528 | 178.5 | 263.5 | 297.1 | 288 | 246.7 |
| viscosity at 997 s-1 | | | | | | | | | |
| at 290 deg C. (Pa) | | | | | | | | | |
| Capillary shear | 102.3 | 54.4 | 102.6 | 182 | 77.1 | 107 | 116.1 | 109.2 | 101.9 |
| viscosity at 5886 s-1 | | | | | | | | | |
| at 290 deg C. (Pa) | | | | | | | | | |

Impact (mechanical) properties

### EXAMPLES J-K & 19-29

The blends shown in Table 5 were extruded by a twin-screw extruder. Samples J and K without either an epoxy or an ionomer additive show poor mechanical properties. Addition of either (i) epoxies with functionality levels greater than or equal to 2 or (ii) polyester ionomers improve the mechanical properties significantly.

TABLE 5
Effect of epoxies and ionomers on properties of Polyamide and block
copolyestercarbonate blends. PBT-Ionomer polymer contains 10% ionomer
while PCCD-Ionomer polymer contains ionomer of level-5%.

| Ingredient | J | 19 | 20 | 21 | 22 | 23 | 24 |
|---|---|---|---|---|---|---|---|
| Selar | 10 | 10 | 10 | 10 | 10 | 10 | 10 |
| ITR20 | 90 | 90 | 90 | 90 | 90 | 90 | 90 |
| Heat Stabilizers | 0.35 | 0.35 | 0.35 | 0.35 | 0.35 | 0.35 | 0.35 |
| Epoxy-type | | ADD-310 | Epon 1001F | ADR4315 | ADR 4368 | | |
| Epoxy-level (%) | | 0.5 | 0.5 | 0.5 | 0.25 | | |
| ˜Epoxy | | 1-2 | 2 | 3-4 | 20-24 | | |
| functionality per | | | | | | | |
| chain | | | | | | | |
| Ionomer-type | | | | | | PBT | PCCD |
| Ionomer level (%) | | | | | | 1 | 1 |
| Was delamination | Yes | No | No | No | No | No | No |
| observed?? | | | | | | | |
| Dynatup energy | 48 | 50 | 54 | 51 | 48 | 50.4 | 50 |
| (ft-lbf) | | | | | | | |
| Dynatup ductility | 0 | 0 | 100 | 0 | 100 | 100 | 0 |
| (%) | | | | | | | |
| Notched Izod | 9.39 | 5.6 | 17.64 | 17.24 | 18.3 | 18.2 | 9 |
| energy | | | | | | | |
| Notched Izod | 40 | 20 | 100 | 100 | 100 | 100 | 40 |
| ductility (%) | | | | | | | |
| Transmission | 86.8 | 87.9 | 88.2 | 88.2 | 87.7 | 88.1 | 85.6 |

TABLE 6
Effect of stabilizers on impact properties of blends

| Ingredient | K | 25 | 26 | 27 | 28 | 29 |
|---|---|---|---|---|---|---|
| Selar | 25 | 25 | 25 | 25 | 25 | 25 |
| ITR20 | 75 | 75 | 75 | 75 | 75 | 75 |
| Heat | 0.35 | 0.35 | 0.35 | 0.35 | 0.35 | 0.35 |
| Stabilizers | | | | | | |
| Epoxy-type | | ADD- | Epon | Epon | ADR | Epon |
| | | 4310 | 1009F | 1009F | 4368 | 1009F |
| Epoxy-level | | 0.5 | 0.5 | 1.5 | 0.25 | 3 |
| (%) | | | | | | |
| ˜Epoxy | 1-2 | 2 | 2 | 20-24 | 2 | |
| functionality | | | | | | |
| per chain | | | | | | |
| Ionomer-type | | | | | | PBT |
| Ionomer level | | | | | | 1 |
| (%) | | | | | | |
| Dynatup | 17.3 | 40 | 46 | 54 | 56 | 49.4 |
| energy | | | | | | |
| (ft-lbf) | | | | | | |
| Notched Izod | 1.47 | 2 | 2.5 | 3.6 | 1.5 | 4.47 |
| energy | | | | | | |
| Transmission | 87.7 | 87.9 | 87.7 | 86.7 | 80.4 | 86.6 |

*Heat stabilizers: 0.2% Irgafos 168, 0.1% Irganox 1010, and 0.05% Seenox 412S.

### EXAMPLES L-N & 30-38—OPTICAL PROPERTIES

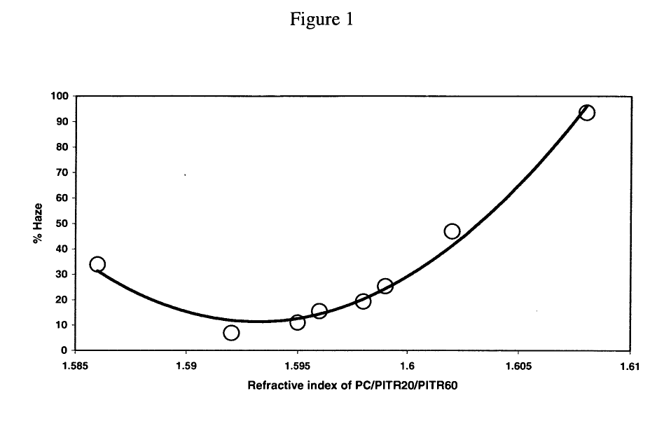

Transparent binary and ternary blends have been obtained by compounding the amorphous polyamides with block copolyestercarbonate and polycarbonate. FIG. 1 shows the change in % Haze of Selar with PC/ITR20/ITR60 blends. In the figure, the refractive index is a weight average of refractive index of PC/ITR20/ITR60. Table 5 provide example of the various blend formulations and optical properties for Selar as the polyamide. It is interesting to note that PC is completely miscible with ITR-20 (80% PC and 20% ITR copolymer) and ITR 20 has shown miscibility with ITR-60 (60% PC and 40% ITR copolymer) while none of the polymers are miscible with amorphous polyamide.

TEMs have shown that while the blend is optically transparent, it is immiscible, indicating that the optical clarity is due to the refractive index matching not due to the chemical miscibility. The ability to tune refractive index of block copolyestercarbonate therefore allows for a precise RI match with any transparent polyamide with an RI in this range.

TABLE 7
Various formulations of the Selar/block copolyestercarbonate blends with the relevant optical data.

| Ingredient | L | M | N | 30 | 31 | 32 | 33 | 34 | 35 | 36 | 37 | 38 |
|---|---|---|---|---|---|---|---|---|---|---|---|---|
| Selar | 100 | | | 75 | 75 | 75 | 75 | 50 | | | | |
| ITR20 | | 100 | | | 10 | 20 | 25 | 50 | | | 23 | 31.5 |
| ITR60 | | | | 25 | 15 | 5 | | | | | | |
| GTR45 | | | 100 | | | | | | 25 | 75 | 63 | 50 |
| PC | | | | | | | | | 75 | 25 | 14 | 18.5 |
| Irgafos 168 | | | | 0.2 | 0.2 | 0.2 | 0.2 | 0.2 | 0.2 | 0.2 | 0.2 | 0.2 |
| Irganox 1010 | | | | 0.1 | 0.1 | 0.1 | 0.1 | 0.1 | 0.1 | 0.1 | 0.1 | 0.1 |
| Seenox 412S | | | | 0.05 | 0.05 | 0.05 | 0.05 | 0.05 | 0.05 | 0.05 | 0.05 | 0.05 |
| ADR 4368 | | | | 0.25 | 0.25 | 0.25 | 0.25 | 0.25 | 0.25 | 0.25 | 0.25 | 0.25 |
| Calculated RI | 1.592 | 1.592 | 1.59 | 1.608 | 1.602 | 1.596 | 1.592 | 1.592 | 1.586 | 1.586 | 1.59 | 1.59 |
| Transmission | 89 | 84 | 89 | 48 | 65 | 82 | 86 | 85 | 82 | 78 | 80 | 82 |
| YI | 4 | 1 | 4.3 | 38 | 35 | 15 | 8 | 8 | 7 | 9 | 10 | 11 |

1. A composition comprising a polymer blend of a polyamide resin and a block copolyestercarbonate resin comprising organic carbonate blocks alternating with arylate blocks, said arylate blocks comprising arylate structural units derived from a 1,3-dihydroxybenzene and at least one aromatic dicarboxylic acid and having a degree of polymerization of at least about 4.

2. The composition of claim 1 wherein the polyamide resin comprises an amorphous polyamide resin.

3. The composition of claim 1 wherein the polyamide resin is immiscible with said block copolyestercarbonates resin.

4. The composition of claim 1 wherein the polymer blend has a percent transmittance, as measured by ASTM D1003, of greater than or equal to about 50%.

5. The composition of claim 1 wherein the polymer blend has a percent transmittance, as measured by ASTM D1003, of greater than or equal to about 75%.

6. The composition of claim 1 wherein the polymer blend polymer of a polyamide resin and block copolyestercarbonate resin comprises from 1 to about 99 percent by weight polyamide resin and from about 1 to about 99 percent by weight block copolyestercarbonates resin.

7. The composition of claim 1 wherein the polymer blend of a polyamide resin and block copolyestercarbonate resin comprises from 75 to about 90 percent by weight polyamide resin and from about 25 to about 10 percent by weight block copolyestercarbonate resin.

8. The composition of claim 1 wherein the polymer blend polymer blend of a polyamide resin and block copolyestercarbonate resin comprises from 10 to about 90 percent by weight polyamide resin and from about 10 to about 90 percent by weight block copolyestercarbonates resin.

9. The composition of claim 1 wherein polyestercarbonate resin is a the resorcinol based copolymer containing carbonate linkages having the structure: 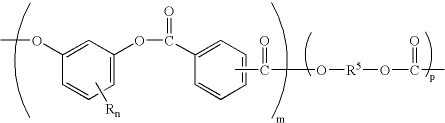
wherein Rn is at least one of C1-12 alkyl, C6-C24 aryl, alkyl aryl or halogen, n is 0-3. R5 is at least one divalent organic radical, m is about 4-150 and p is about 2-200.

10. The composition of claim 9 wherein R5 is derived from a bisphenol compound.

11. The composition of claim 1 wherein the polyamide resin comprises aliphatic, aromatic or a combination of aliphatic and aromatic polyamides.

12. The composition of claim 1 wherein the polyamide resin is optically transparent.

13. The composition of claim 1 wherein the polyamide resin comprises a blend of polyamide resins.

14. The composition of claim 1 additionally comprises 0-50% polycarbonate resin.

15. The composition of claim 1 additionally comprises 0-50% of a polyester resin.

16. The composition of claim 15 wherein the polyester is selected from polyesters made of fragments from at least one diol and at least one dicarboxylic acid.

17. The composition of claim 1 comprising a reactive compatibilizer.

18. The composition of claim 17 comprising a reactive ionomeric, epoxy, or oxaoline compatibilizer.

19. The composition of claim 18 comprising a reactive ionomeric polymeric sulfonate compatibilizer.

20. The composition of claim 18 comprising a reactive epoxy compatibilizer.

21. The composition of claim 18 comprising a reactive oxaoline compatibilizer comprising a pendant cyclic iminoether cyclic.

22. The composition of claim 1 including additional ingredients comprising suitable dyes, pigments, special color effects additives, mold release agents, antioxidants, lubricants, nucleating agents, stabilizers, reinforcing fillers, flame retardants, impact modifiers, flow aids or mold release agents,

23. A formed article comprising the composition of claim 1 wherein the polymer blend of a polyamide resin and block copolyestercarbonates resin comprises from 10 to about 90 percent by weight polyamide resin and from about 10 to about 90 percent by weight block copolyestercarbonates resin.

24. A formed article according to claim 23 comprising a film or sheet.

25. A formed article according to claim 23 having enhanced chemical resistance.

26. A formed article according to claim 23 having transparent properties wherein said polyamide and said copolyestercarbonate resin have substantially matching indexes of refraction.

27. A formed article according to claim 23 having transparent properties wherein said polycarbonate resin, is present in an amount for adjusting the index of refraction of the miscible blend for enhancing transparency.
